(19) United States
(12) Patent Application Publication
(10) Pub. No.: US 2014/0131496 A1
(43) Pub. Date: May 15, 2014

(54) GRANULATING KNIFE

(71) Applicant: ECON GMBH, WEISSKIRCHEN/TRAUN (AT)

(72) Inventor: Gerhard HEHENBERGER, Eggendorf (AT)

(73) Assignee: ECON GMBH, WEISSKIRCHEN/TRAUN (AT)

(21) Appl. No.: 14/065,744

(22) Filed: Oct. 29, 2013

(30) Foreign Application Priority Data
Nov. 12, 2012 (AT) A50506/2012

(51) Int. Cl. B29B 9/06

(52) U.S. Cl. CPC B29B 9/06
USPC 241/291

(57) ABSTRACT

A granulating knife (6) is described for a knife head (5) of a granulating apparatus, wherein the knife body (8) forms a cutting edge (9) and a face (10) originating from the cutting edge (9). In order to improve the operational lifespan of the granulating knives (6) it is proposed that the face (10) is provided with a coating which is harder in comparison with the remainder of the knife body (8).

### CROSS REFERENCE TO RELATED APPLICATIONS

Applicant claims priority under 35 U.S.C. §119 of Austrian Application No. A50506/2012 filed on Nov. 12, 2012, the disclosure of which is incorporated by reference.

### BACKGROUND OF THE INVENTION

1. Field of the Invention

The invention relates to a granulating knife for a cutter head of a granulating apparatus, wherein the knife body forms a cutting edge and a face originating from the cutting edge.

2. Description of the Related Art

For the purpose of granulating thermoplastic materials, the molten plastic materials are conveyed through nozzles arranged in the area of a perforated plate in order to enable the severing of the setting plastic strands by means of a cutter head, said cutter head having a rotational axis concentric to the graduated circles of the nozzles and carrying a plurality of granulating knives which are distributed over the circumference and are pressed by the cutter head against a perforated plate. The frictional forces between the perforated plate and the granulating knives lead to wear and tear which does not lead to constant wear and tear however over the length of the cutting edge in the region of the granulating knife, but produces higher attrition in the region of the passage holes of the perforated plates, which thus considerably impairs the operational lifespan of the granulating knives. For the purpose of improving the wearing resistance of the granulating knives it has already been proposed to produce the granulating knives of a respectively wear-proof material. Granulating knives with a higher resistance to wear and tear lead to higher wear and tear in the region of the perforated plate.

### SUMMARY OF THE INVENTION

The invention is therefore based on the object of providing granulating knives for a granulating apparatus for plastic materials in such a way that the operational lifespan of the granulating knives can be increased without having to accept higher wear and tear in the region of the perforated plate.

On the basis of a granulating knife of the kind mentioned above, this object is achieved by the invention in such a way that the face is provided with a harder coating in comparison with the remainder of the knife body.

The invention is based on the finding that the edge of the passage holes in the perforated plate which is at the rear in the direction of rotation of the cutter head lead to higher wear and tear of the cutting edges in the overlap region of the granulating knives with the passage holes when the cutting edges are moved over said rear edge of the hole under respective pressing force. If therefore the face of the granulating knives originating from the cutting edge is provided with a harder coating that is more resistant to wear and tear, a higher wearing resistance is given to the wear and tear of the cutting edge loaded from the side of the face over the rear edges of the hole, which wearing resistance leads to a considerable increase in the operational lifespan of the granulating knives without relevantly changing the frictional conditions between the granulating knives and the perforated plate because the knife body per se need not be provided with any higher hardness.

Good adherence to the knife body is very important for coating the face in order to extend the operational lifespan of the granulating knives, because the effect of the coating would be cancelled in the case of a detachment of the coating in the area of the cutting edge which is especially susceptible to such detachment. In order to ensure advantageous bonding conditions, the coating can be applied by high-speed flame-spraying onto the face of the granulating knife, thus ensuring a durable coating of the knife body on the one hand and providing the possibility on the other hand to apply thin layers on the wedge surfaces, thereby relevantly improving the wearing behaviour of the cutting edges and simultaneously hardly having an influence on the frictional conditions between the knife body and the perforated plate.

### BRIEF DESCRIPTION OF THE DRAWINGS

The subject matter of the invention is shown by way of example in the drawings, wherein:

FIG. 1 shows a simplified sectional view of a conventional granulating apparatus in the region of a granulating knife in accordance with the invention operating with a perforated plate, and

FIG. 2 shows the granulating knife in the region of its cutting edge in a view perpendicular to the perforated plate on an enlarged scale.

### DETAILED DESCRIPTION OF PREFERRED EMBODIMENTS

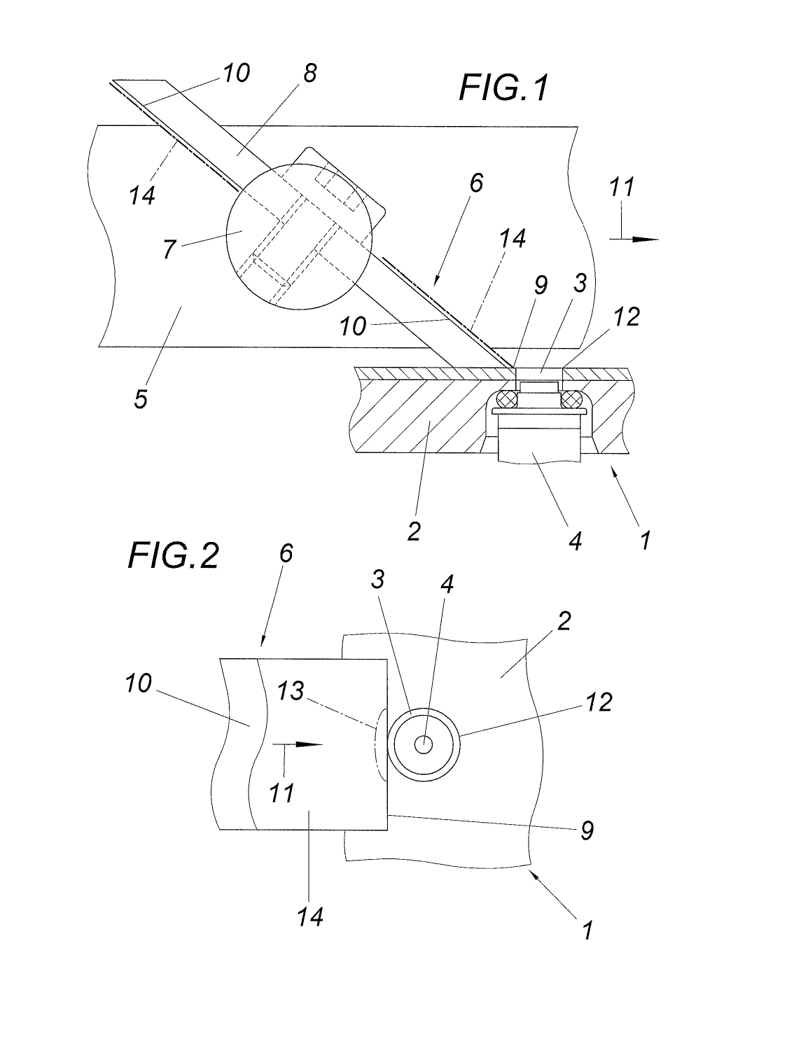

The granulating apparatus shown in FIG. 1 conventionally comprises a granulating head 1 (not shown in closer detail) which comprises a perforated plate 2 with passage holes 3 arranged along at least part of a graduated circle into which the nozzles 4 protrude. Plastic strands pass through the nozzles 4, which solidify and are severed into small pieces by means of a cutter head 5. For this purpose, the cutter head 5 comprises a ring of granulating knives 6 which is coaxial to the graduated circle of the nozzles 4 and therefore the passage holes 3 of the perforated plate 2, which granulating knives are tightly clamped in knife holders 7. Said granulating knives 6 respectively form a knife body 8 which is provided with a cutting edge 9 from which a face 10 originates. The granulating knives 6 which are pressed by the cutter head 5 against the perforated plate 2 are driven concentrically to the graduated circle of the passage holes 3 in the perforated plate 2. The direction of rotation 11 is indicated by the arrow.

The solidifying plastic strand which emerges from the nozzles 4 and through the passage holes 3 in the perforated plate 2 is severed by means of the granulating knife 6, wherein irregular wear and tear occurs in the region of the cutting edge 9 because the cutting edge 9 is loaded especially by the edge 12 of the passage holes in the perforated plate 2, which edge is at the rear in the direction of rotation 11. Wearing 13 of the cutting edge 9 would therefore occur without any special measures, as indicated by the dot-dash line in FIG. 2.

In order to reduce this wear and tear 13, the face 10 of the knife body 8 is provided with a coating 14 which offers higher resistance to wear and tear and which increases the wearing resistance of the cutting edge 9 of the knife body 8 in the region of the face 10 loaded by the rear edge 12 of the hole without relevantly influencing the frictional conditions between the knife body 8 and the perforated plate 2, since the knife body 8 per se can be produced from a comparatively soft material. This means that the operational lifespan of such granulating knives 6 which are provided with a coating 14 which offers a higher wearing resistance can be increased considerably. The precondition for this is that the coating 14 which is applied in a comparatively thin manner to the knife body is provided with sufficient adherence to the face 10. This adherence can advantageously be ensured in such a way that the coating is applied by high-temperature flame-spraying.

As is shown in FIG. 1, the granulating knives can be arranged as reversing knives. In this case it is necessary to provide the coatings 14 on both sides of the reversing knives.

What is claimed is:

1. A granulating knife (6) for a cutter head (5) of a granulating apparatus, wherein the knife body (8) forms a cutting edge (9) and a face (10) originating from the cutting edge (9), wherein the face (10) is provided with a coating (14) which is harder in comparison with the remainder of the knife body (8).

2. A granulating knife (6) according to claim 1, wherein in the coating (14) is applied by means of high-speed flame-spraying to the face (10) of the knife body (8).
